(19) United States
(12) Patent Application Publication
(10) Pub. No.: US 2014/0266039 A1
(43) Pub. Date: Sep. 18, 2014

(54) Systems and Methods for Controlling a Charging Device

(71) Applicant: GENERAL ELECTRIC COMPANY, Schenectady, NY (US)

(72) Inventor: John James Dougherty, Collegeville, PA (US)

(73) Assignee: GENERAL ELECTRIC COMPANY, Schenectady, NY (US)

(21) Appl. No.: 13/803,030

(22) Filed: Mar. 14, 2013

(51) Int. Cl. B60L 11/18

(52) U.S. Cl. CPC B60L 11/1844; B60L 11/1824
USPC 320/109; 320/137

(57) ABSTRACT

A charging device for use with an electric vehicle including a power storage device is provided. The charging device includes a current control device configured to selectively enable current to be received at the charging device from an electrical distribution device and supplied to a power storage device connected to the charging device, and a processor coupled to the current control device. The processor is configured to assign, based at least in part on a connect time of the power storage device to the charging device, a current allocation to said charging device, and control the current control device to enable the current allocation to be at least one of received from the electrical distribution device and supplied by the charging device.

### BACKGROUND

The present application relates generally to charging devices and, more particularly, to allocating current based on a connect time between a charging device and a power storage device.

As electric vehicles and/or hybrid electric vehicles have gained popularity, an associated need to manage delivery of electrical energy to such vehicles has increased. In addition, a need to provide safe and efficient charging devices or stations has been created by the increased use of such vehicles.

At least some known charging stations include a power cable or other conductor that may be removably coupled to the electric vehicle. The charging stations receive electricity from an electric utility distribution network or another electricity source, and deliver electricity to the electric vehicle through the power cable.

In at least some known electric utility distribution networks, a plurality of charging devices receive electricity from a common electrical distribution component, such as a transformer. However, if each charging device operates concurrently to supply charging current to an electric vehicle, the current supplied to the electrical distribution component may exceed a rated current limit of the component. In such situations, the electrical distribution component may be damaged and/or a circuit breaker or another protection device may activate to disable power to all charging devices coupled to the electrical distribution component.

Further, in at least some known electric utility distribution networks, charging current is provided on an equal access basis. That is, an amount of total available current is split equally between all charging vehicles, regardless of whether some vehicles arrived earlier than others. Moreover, in at least some known electrical utility distribution networks, utilities set differential rates for customers who exceed a specific demand level during a billing period. These differential rates, also described herein as overage charges, can apply for the entire billing period for even one instance of exceeded demand during the billing period.

### BRIEF DESCRIPTION

In one aspect, a charging device for use with an electric vehicle including a power storage device is provided. The charging device includes a current control device configured to selectively enable current to be received at the charging device from an electrical distribution device and supplied to a power storage device connected to the charging device, and a processor coupled to the current control device. The processor is configured to assign, based at least in part on a connect time of the power storage device to the charging device, a current allocation to said charging device, and control the current control device to enable the current allocation to be at least one of received from the electrical distribution device and supplied by the charging device.

In another aspect, a system for use in providing current to a plurality of electric vehicles is provided. The system includes a first charging device configured to receive current from an electrical distribution device and supply at least a portion of the current received to a first power storage device, a second charging device configured to receive current from the electrical distribution device and supply at least a portion of the received current to a second power storage device, and a processor. The processor is configured to determine a first connect time of the first charging device to the first power storage device, determine a second connect time of the second charging device to the second power storage device, and assign a current allocation to the first and second charging devices based at least in part on the first and second connect times.

In yet another aspect, a method for allocating current to a plurality of charging devices communicatively coupled to one another over a peer-to-peer network and each connected to a respective power storage device is provided. The method includes broadcasting, from each of the plurality of charging devices, a status message that includes a connect time of the respective charging device, receiving, at a processor, the plurality of status messages, and calculating, using the processor, a current allocation for each of the plurality of charging devices based at least in part on the connect time of each charging device.

### BRIEF DESCRIPTION OF THE DRAWINGS

FIG. 1 is a block diagram of an exemplary system for charging an electric vehicle.

FIG. 2 is a block diagram of an exemplary charging device that may be used with the system shown in FIG. 1.

FIG. 3 is a block diagram of an exemplary charging system for charging a plurality of electric vehicles that may be used with the system shown in FIG. 1.

FIG. 4 is a flow diagram of an exemplary method for allocating current that may be used with the charging system shown in FIG. 3.

FIG. 5 is a flow diagram of an exemplary method for allocating current that may be used with the charging system shown in FIG. 3.

FIG. 6 is a flow diagram of an exemplary method for allocating current that may be used with the charging system shown in FIG. 3.

FIG. 7 is a flow diagram of an exemplary method that may be used with the charging device shown in FIG. 2.

FIG. 8 is a flow diagram of an exemplary method for allocating current that may be used with the charging system shown in FIG. 3.

### DETAILED DESCRIPTION

In some embodiments, the term “electric vehicle” refers generally to a vehicle that includes one or more electric motors. Energy used by the electric vehicles may come from various sources, such as, but not limited to, an on-board rechargeable battery and/or an on-board fuel cell. In one embodiment, the electric vehicle is a hybrid electric vehicle, which captures and stores energy generated, for example, by braking. In addition, a hybrid electric vehicle uses energy stored in an electrical source, such as a battery, to continue operating when idling to conserve fuel. Some hybrid electric vehicles are capable of recharging the battery by plugging into a power receptacle, such as a power outlet. Accordingly, the term “electric vehicle” as used herein may refer to a hybrid electric vehicle or any other vehicle to which electrical energy may be delivered, for example, via the power grid.

FIG. 1 illustrates an exemplary system 100 for use in charging, or providing electricity to, an electric vehicle 102. In an exemplary embodiment, system 100 includes a charging device 104 coupled to electric vehicle 102. In an exemplary embodiment, electric vehicle 102 includes at least one power storage device 106, such as a battery and/or any other storage device, coupled to a motor 108. In an exemplary embodiment, electric vehicle 102 includes a vehicle controller 110 coupled to power storage device 106.

In an exemplary embodiment, charging device 104 is removably coupled to power storage device 106 and to vehicle controller 110 by at least one power conduit 112. Alternatively, charging device 104 may be coupled to power storage device 106 and/or vehicle controller 110 by any other conduit or conduits, and/or charging device 104 may be coupled to vehicle controller 110 by a wireless data link (not shown) and/or by inductive coupling such that no conduit 112 is used. In an exemplary embodiment, power conduit 112 includes at least one conductor (not shown) for supplying electricity to power storage device 106 and/or to any other component within electric vehicle 102, and at least one conductor (not shown) for transmitting data to, and receiving data from, vehicle controller 110 and/or any other component within electric vehicle 102. Alternatively, power conduit 112 may include a single conductor that transmits and/or receives power and/or data, or any other number of conductors that enables system 100 to function as described herein. In an exemplary embodiment, charging device 104 is coupled to an electric power source 114, such as a power grid of an electric utility company, a generator, a battery, and/or any other device or system that provides electricity to charging device 104.

In an exemplary embodiment, charging device 104 is coupled to at least one server 116 through a network, such as the Internet, a local area network (LAN), a wide area network (WAN), and/or any other network or data connection that enables charging device 104 to function as described herein. Server 116, in an exemplary embodiment, communicates with charging device 104, for example, by transmitting a signal to charging device 104 to authorize payment and/or delivery of electricity to power storage device 106, to access customer information, and/or to perform any other function that enables system 100 to function as described herein.

In an exemplary embodiment, server 116 and vehicle controller 110 each include at least one processor and at least one memory device. The processors each include any suitable programmable circuit which may include one or more systems and microcontrollers, microprocessors, reduced instruction set circuits (RISC), application specific integrated circuits (ASIC), programmable logic circuits (PLC), field programmable gate arrays (FPGA), and any other circuit capable of executing the functions described herein. The above examples are exemplary only, and thus are not intended to limit in any way the definition and/or meaning of the term “processor.” The memory devices each include a computer readable medium, such as, without limitation, random access memory (RAM), flash memory, a hard disk drive, a solid state drive, a diskette, a flash drive, a compact disc, a digital video disc, and/or any suitable memory device that enables the processors to store, retrieve, and/or execute instructions and/or data.

During operation, in an exemplary embodiment, a user couples power storage device 106 to charging device 104 with power conduit 112. The user may access a user interface (not shown in FIG. 1) of charging device 104 to enter information, such as payment information, and/or to initiate power delivery to power storage device 106. Charging device 104 is configured to communicate with server 116, for example, to authenticate the user, to process the payment information, and/or to approve or authorize the power delivery. If charging device 104 receives a signal from server 116 that indicates approval or authorization to deliver power to power storage device 106, charging device 104 receives power from electric power source 114 and provides the power to power storage device 106 through power conduit 112. Charging device 104 communicates with vehicle controller 110 wirelessly, through power conduit 112, and/or through any other conduit, to control and/or to monitor the delivery of power to power storage device 106. For example, vehicle controller 110 may transmit signals to charging device 104 indicating a charge level of power storage device 106 and/or a desired amount and/or rate of power to be provided by charging device 104. Charging device 104 may transmit signals to vehicle controller 110 indicating an amount and/or rate of electricity being delivered to power storage device 106. Additionally or alternatively, charging device 104 and/or vehicle controller 110 may transmit and/or receive any other signals or messages that enable system 100 to function as described herein. When power storage device 106 has been charged to a desired level, charging device 104 ceases delivering power to power storage device 106 and the user disengages power conduit 112 from power storage device 106.

FIG. 2 is a block diagram of an exemplary charging device 104 that may be used with system 100 (shown in FIG. 1). In an exemplary embodiment, charging device 104 includes a controller 200 that includes a processor 202 and a memory device 204. As described more fully herein, controller 200 is coupled to a network interface 206, to a display 208, to a user interface 210, to a meter 212, and to a current control device 214.

Processor 202 includes any suitable programmable circuit which may include one or more systems and microcontrollers, microprocessors, reduced instruction set circuits (RISC), application specific integrated circuits (ASIC), programmable logic circuits (PLC), field programmable gate arrays (FPGA), and any other circuit capable of executing the functions described herein. The above examples are exemplary only, and thus are not intended to limit in any way the definition and/or meaning of the term “processor.” Memory device 204 includes a computer readable medium, such as, without limitation, random access memory (RAM), flash memory, a hard disk drive, a solid state drive, a diskette, a flash drive, a compact disc, a digital video disc, and/or any suitable device that enables processor 202 to store, retrieve, and/or execute instructions and/or data.

Network interface 206, in an exemplary embodiment, transmits and receives data between controller 200 and a remote device or system. In an exemplary embodiment, network interface 206 is communicatively coupled to at least one other charging device 104 such that charging devices 104 transmit and receive data to and from each other. In an exemplary embodiment, network interface 206 is coupled to a network interface 206 of at least one other charging device 104 using any suitable data conduit, such as an Ethernet cable, a Recommended Standard (RS) 485 compliant cable, and/or any other data conduit that enables charging device 104 to function as described herein. Alternatively, network interface 206 communicates wirelessly with a network interface 206 of at least one other charging device 104 using any suitable wireless protocol.

In an exemplary embodiment, display 208 includes a vacuum fluorescent display (VFD) and/or one or more light-emitting diodes (LED). Additionally or alternatively, display 208 may include, without limitation, a liquid crystal display (LCD), a cathode ray tube (CRT), a plasma display, and/or any suitable visual output device capable of displaying graphical data and/or text to a user. In an exemplary embodiment, a charging status of power storage device 106 (shown in FIG. 1), payment information, user authentication information, and/or any other information may be displayed to a user on display 208.

User interface 210 includes, without limitation, a keyboard, a keypad, a touch-sensitive screen, a scroll wheel, a pointing device, a barcode reader, a magnetic card reader, a radio frequency identification (RFID) card reader, a contactless credit card reader, a near field communication (NFC) device reader, an audio input device employing speech-recognition software, and/or any suitable device that enables a user to input data into charging device 104 and/or to retrieve data from charging device 104. In an exemplary embodiment, the user may operate user interface 210 to initiate and/or terminate the delivery of power to power storage device 106. In one embodiment, the user may input user authentication information and/or payment information using user interface 210.

In an exemplary embodiment, current control device 214 is coupled to power conduit 112 and to meter 212. In an exemplary embodiment, current control device 214 is a contactor 214 coupled to, and controlled by, controller 200. In an exemplary embodiment, controller 200 operates, or opens contactor 214 to interrupt the current flowing through power conduit 112 such that power storage device 106 is electrically disconnected from electric power source 114 (shown in FIG. 1). Controller 200 closes contactor 214 to enable current to flow through power conduit 112 such that power storage device 106 is electrically connected to electric power source 114.

In an exemplary embodiment, meter 212 is coupled to power conduit 112 and to controller 200 for use in measuring and/or calculating the current, voltage, power, and/or energy provided from electric power source 114 to power storage device 106. Meter 212 transmits data representative of the measured current, voltage, power, and/or energy to controller 200. In an alternative embodiment, controller 200 includes meter 212 and/or the functionality of meter 212.

In an exemplary embodiment, a current protection device 216 is coupled to meter 212 and to electric power source 114. Alternatively, current protection device 216 may be located at electric power source 114 to protect both internal and external wiring/components of charging device 104. Current protection device 216 electrically isolates or disconnects charging device 104 from electric power source 114 if the current received from electric power source 114 exceeds a predetermined threshold or current limit. In an exemplary embodiment, current protection device 216 is a circuit breaker. Alternatively, current protection device 216 may be a fuse, a relay, and/or any other device that enables current protection device 216 to function as described herein.

During operation, power storage device 106 of electric vehicle 102 is coupled to charging device 104 using power conduit 112. In one embodiment, a user obtains authorization from server 116 and/or another system or device to enable charging device 104 to charge (i.e., to provide current to) power storage device 106. As described more fully herein, charging device 104 determines an amount of current to provide to power storage device 106 and/or determines whether sufficient capacity, such as transmission or distribution capacity, exists to provide current to power storage device 106.

FIG. 3 is a block diagram of an exemplary charging system 300 that may be used to charge a plurality of electric vehicles 102, such as by charging a power storage device 106 (both shown in FIG. 2) of each electric vehicle 102. In an exemplary embodiment, charging system 300 includes a plurality of charging devices 104, such as a first charging device 302, a second charging device 304, a third charging device 306, and a fourth charging device 308. While FIG. 3 illustrates four charging devices 104, charging system 300 may include any number of charging devices 104 as desired.

In an exemplary embodiment, charging devices 104 are coupled to a common electrical distribution device 310 through respective power conduits 312. In an exemplary embodiment, electrical distribution device 310 is a transformer that adjusts a distribution voltage received from electric power source 114 to a voltage suitable for use with charging devices 104. Alternatively, electrical distribution device 310 may be any other device that enables charging system 300 to function as described herein. In an exemplary embodiment, electrical distribution device 310 distributes an allocated of current to each charging device 104 until the distributed current reaches a current distribution limit. For example, electrical distribution device 310 may be designed or “rated” to distribute a predefined amount of current. Accordingly, the current distribution limit may be set to the predefined amount of current or a current level below the predefined amount. As described more fully herein, each charging device 104 determines an allocation of current to draw (or receive) from electrical distribution device 310 and/or to supply to power storage devices 106 based on the current distribution limit and based on at least a connect time associated with each charging device 104. For example, the amount of current received from electric power source 114 may be different than the amount of current supplied to a power storage device 106 coupled to a charging device 104 as a result of current consumption within charging device 104 and/or current consumption by one or more loads, other than power storage devices 106, coupled to charging device 104.

Charging devices 104, in an exemplary embodiment, are coupled together in data communication by a data bus 314. More specifically, charging devices 104 are coupled to data bus 314 by respective network interfaces 206 (shown in FIG. 2). In an exemplary embodiment, data bus 314 includes at least one data conduit (not shown), such as an Ethernet cable, a Recommended Standard (RS) 485 compliant cable, and/or any other data conduit that enables data bus 314 to function as described herein. Alternatively, charging devices 104 are coupled together in data communication by a wireless network. In an exemplary embodiment, charging devices 104 and/or data bus 314 form a peer-to-peer network 316 that enables each charging device 104 to exchange data with other charging devices 104 coupled to network 316 without requiring a master controller. Alternatively, charging devices 104 and/or data bus 314 may form any other network that enables charging system 300 to function as described herein. For example, in at least some embodiments, instead of or in addition to communicating directly with one another, charging devices 104 exchange data with a central control system (not shown).

In an exemplary embodiment, charging devices 104 each periodically broadcast a status message over peer-to-peer network 316. The status message may include a unique identifier, a connect status, a priority tier, a connect time, a current demand, a previous current allocation, a number of active units, and/or a peer communication error flag, as described in more detail herein. The status messages may be broadcast, for example, once a second (i.e., 1 Hertz).

The unique identifier identifies the charging station 104 broadcasting the status message. The connect status indicates whether or not a power storage device 106 is currently connected to charging device 104. The priority tier establishes a current allocation priority for a power storage device 106 connected to charging device 104, as described in more detail herein.

In an exemplary embodiment, the connect time of charging device 104—is a length of time that power storage device 106 has been connected to and receiving current from charging device 104. Alternatively, the connect time may be any measure of time that enables charging system 300 to function as described herein.

The current demand indicates an amount of current requested by charging device 104 and/or power storage device 106. The amount of current allocated to charging device 104 and/or power storage device 106 may be determined based at least in part on the current demand. The current demand may be generated, for example, by vehicle controller 110 (shown in FIG. 1) or controller 200 (shown in FIG. 2. The previous current allocation indicates the amount of current allocated to charging device 104 and/or power storage device 106 for a previous cycle. The peer communication error flag indicates communication failures on peer-to-peer network 316, as described in more detail below.

In an exemplary embodiment, all charging devices 104 in charging system 300 broadcast a status message at the same time, and each charging device 104 receives the status message broadcast from every other charging device 104. From the received status messages, each charging device 104 calculates a separate current allocation for each charging device 104, as described in more detail below. As will be appreciated by those of skill in the art, although referred to herein as allocating current, the methods and systems described herein also allocate power (i.e., current provided at a voltage) to charging devices 104.

In an exemplary embodiment, the current allocations are calculated based using a first-come first-served methodology. In general, the longer the connect time of a power storage device 106 to an associated charging device 104, the more current is allocated to that power storage device 106 and/or associated charging device 104.

FIG. 4 is a flow diagram of an exemplary method 400 that may be used with charging device 104. In an exemplary embodiment, method 400 is performed using processor 202 (shown in FIG. 2). Alternatively, method 400 may be performed by a central control system (not shown) communicatively coupled to charging device 104. Method 400 is constitutes one cycle of a periodic current allocation scheme. Each cycle is performed in response to charging devices 104 broadcasting their respective status messages. The frequency with which the cycle is performed may be, for example, 1 Hertz. In an exemplary embodiment, at the beginning of each cycle, the current allocation for all charging devices 104 is reset.

At block 402, a connect time is determined for all currently connected charging devices 104 (i.e., all charging devices 104 in charging system 300 that are currently connected to an associated power storage device 106). In an exemplary embodiment, charging device 104 determines the connect times from the status messages broadcast over peer-to-peer network 316.

At block 404, a total available current is determined. The total available current is the amount of current that electrical distribution device 310 is able to provide to charging devices 104 without incurring overage charges. The total available current may depend on the current date and/or time. For example, charging devices 104 may store charging requirements in memory device 204 (shown in FIG. 2), and processor 202 may calculate the total available current based on the stored charging requirements and the current date and/or time. Alternatively, the total available current may be determined by a backend computer system (not shown) communicatively coupled to charging devices 104.

If the total available current is exceeded (i.e., if charging devices 104 collectively draw more than the total available current), fines may be imposed on an operator of charging system 300. Accordingly, the systems and methods described herein facilitate ensuring that the total available current is not exceeded. In at least some embodiments, to further prevent incurring fines, the total available current is set as a predetermined percentage (e.g., 95%) of the actual available current.

At block 406, the charging device 104 with the longest connect time is assigned a current allocation equal to the minimum of (i.e., the lesser of) the total available current and the current demand of the charging device 104 and/or power storage device 106 connected to the charging device 104. For example, if the total available current is 100 Amps (A), and the charging device 104 with the longest connect time has a current demand of 56 A, the charging device 104 will be assigned 56 A. The assigned value is the current allocation for that charging device 104.

At block 408, it is determined whether any currently connected charging devices 104 remain unassigned (i.e., whether a current allocation has not been assigned to any currently connected charging devices 104). If there are no remaining unassigned charging devices 104, this cycle of the current allocation scheme ends at block 410. If there are remaining unassigned charging devices 104, flow proceeds to block 412.

At block 412, the remaining available current is calculated. The remaining available current is equal to the total available current minus any current allocations already assigned in the cycle. At block 414, it is determined whether there is any remaining available current (i.e., whether the remaining available current is greater than zero). If there is no remaining available current (i.e., all of the total available current has already been allocated to one or more charging devices 104), the cycle ends at block 410. If there is remaining available current, flow proceeds to block 416.

At block 416, the remaining charging device 104 with the longest connect time is assigned a current allocation equal to a minimum of (i.e., the lesser of) the remaining available current and the current demand of the charging device 104 and/or power storage device 106 connected to the charging device 104. Flow returns to block 408.

Using method 400, charging devices 104 are each assigned a current allocation based on their connect times. For example, suppose the total available current is 100 A, first charging device 302 has a connect time of 10 minutes and a current demand of 25 A, second charging device 304 has a connect time of 20 minutes and a current demand of 15 A, third charging device 306 has a connect time of 15 minutes and a current demand of 50 A, and fourth charging device 308 has a connect time of 5 minutes and a current demand of 40 A. Using method 400, second charging device 304 (having the longest connect time) will be assigned a current allocation of 15 A, third charging device 306 (having the second longest connect time) will be assigned a current allocation of 50 A, first charging device 302 (having the third longest connect time) will be assigned a current allocation of 25 A, and fourth charging device 308 (having the shortest connect time) will be assigned a current allocation of 10 A. Note that fourth charging device 308 will only be assigned a current allocation of 10 A (as opposed to the current demand of 40 A) because the remaining available current is 10 A (i.e., 100 A−15 A−50 A−25 A=10 A). Further, if the total available current was only 90 A, the current allocation for fourth charging device 308 would be 0 A.

In an exemplary embodiment, in the event of a communications failure on peer-to-peer network 316, charging system 300 switches from a first-come first-served current allocation scheme to an equal current allocation scheme, as described herein.

FIG. 5 is a flow diagram of an exemplary method 500 that may be used with charging device 104. In an exemplary embodiment, method 500 is performed using processor 202 (shown in FIG. 2). Alternatively, method 500 may be performed by a central control system (not shown) communicatively coupled to charging device 104. In an exemplary embodiment, method 500 is performed once every cycle.

At block 502, charging device 104 receives status messages broadcast by other charging devices 104 in charging system 300 (shown in FIG. 3). At block 504, charging device 104, and more specifically, processor 202, detects whether there is a communications failure on peer-to-peer network 316 (shown in FIG. 3).

In an exemplary embodiment, charging device 104 detects a communications failure when the number of status messages received (including the status message of the charging device 104 receiving the status messages) is less than the number of active charging devices 104 in charging system 300. Charging device 104 may also detect a communications failure when a received status message includes a peer communications error flag. In an exemplary embodiment, a charging device 104 broadcasts a peer communications error flag when that charging device 104 detects a communications failure on peer-to-peer network 316.

At block 506, to prevent charging devices 104 from collectively drawing more current than the total available current, when charging device 104 detects a communications failure, all charging devices 104 in charging system 300 are allocated an equal amount of current instead of allocating current using a first-come first-served scheme. Specifically, each charging device 104 is allocated the total amount of current divided by the number of charging devices 104 in charging system 300. For example, if the total available current is 100 A, and there are four charging devices 104 in charging system 300, each charging device 104 is allocated 25 A when a communications failure is detected.

In at least some embodiments, the first-come first-served current allocation scheme may also be implemented subject to a priority tier associated with each charging device 104. More specifically, current is allocated within each priority tier based on a first-come first-served scheme. However, all power storage devices 106 in a higher priority tier receive current before power storage devices 106 in lower tiers, as described in more detail herein. Accordingly, subsequent arrivals (i.e., shorter connect times) in higher tiers receive priority over earlier arrivals (i.e., longer connect times) in lower tiers.

As described above, the status message broadcast by each charging device 104 may include the priority tier of associated with charging device 104 and/or power storage device 106 connected to charging device 104. The priority tier may be determined by, for example, an electronic payment card used to purchase energy from charging device 104, an RFID tag associated with electric vehicle 102 that includes power storage device 106. For example, electric vehicles 102 used by emergency personnel (e.g., firefighters, paramedics, etc.) may be assigned a higher priority tier than privately owned electric vehicles 102. Moreover, in at least some embodiments, a user may select a priority tier using user interface 210 (shown in FIG. 2), allowing the user to elect to be charged additional fees in exchange for receiving priority over other, lower tiers. Any suitable number of priority tiers may be utilized.

FIG. 6 is a flow diagram of an exemplary method 600 that may be used with charging device 104. In an exemplary embodiment, method 600 is performed using processor 202 (shown in FIG. 2). Alternatively, method 600 may be performed by a central control system (not shown) communicatively coupled to charging device 104. Method 600 constitutes one cycle of a periodic current allocation scheme. Each cycle is performed in response to charging devices 104 broadcasting their respective status messages. The frequency with which the cycle is performed may be, for example, 1 Hertz. In an exemplary embodiment, at the beginning of each cycle, the current allocation for all charging devices 104 is reset.

At block 602, a connect time is determined for all currently connected charging devices 104 (i.e., all charging devices 104 in charging system 300 that are currently connected to an associated power storage device 106). In an exemplary embodiment, charging device 104 determines the connect times from the status messages broadcast over peer-to-peer network 316. At block 604, a total available current is determined, as described above in connection with method 400 (shown in FIG. 4).

At block 606, the charging device 104 with the longest connect time in the highest priority tier is assigned a current allocation equal to a minimum of (i.e., the lesser of) the total available current and the current demand of the charging device 104 and/or power storage device 106 connected to the charging device 104. For example, if the total available current is 100 Amps (A), and the charging device 104 with the longest connect time in the highest priority tier has a current demand of 56 A, the charging device 104 will be assigned 56 A. The assigned value is the current allocation for that charging device 104.

At block 608, it is determined whether any currently connected charging devices 104 remain unassigned (i.e., whether a current allocation has not been assigned to any currently connected charging device 104). If there are no remaining unassigned charging devices 104, this cycle of the current allocation scheme ends at block 610. If there are remaining unassigned charging devices 104, flow proceeds to block 612.

At block 612, the remaining available current is calculated. The remaining available current is equal to the total available current minus any current allocations already assigned in the cycle. At block 614, it is determined whether there is any remaining available current (i.e., whether the remaining available current is greater than zero). If there is no remaining available current (i.e., all of the total available current has already been allocated to one or more charging devices 104), the cycle ends at block 610. If there is remaining available current, flow proceeds to block 616.

At block 616, the remaining charging device 104 with the longest connect time in the highest priority tier is assigned a current allocation equal to a minimum of (i.e., the lesser of) the remaining available current and the current demand of the charging device 104 and/or power storage device 106 connected to the charging device 104. Flow returns to block 608.

Using method 600, charging devices 104 are each assigned a current allocation based on their connect times within each priority tier. For example, suppose the total available current is 100 A, first charging device 302 is in a highest priority tier, has a connect time of 10 minutes, and has a current demand of 25 A, second charging device 304 is in a lowest priority tier, has a connect time of 20 minutes, and has a current demand of 15 A, third charging device 306 is in a middle priority tier, has a connect time of 15 minutes, and has a current demand of 50 A, and fourth charging device 308 is in the middle priority tier, has a connect time of 5 minutes, and has a current demand of 40 A. Using method 600, first charging device 302 will be assigned a current allocation of 25 A, third charging device 306 will be assigned a current allocation of 50 A, fourth charging device 308 will be assigned a current allocation of 25 A, and second charging device 304 will be assigned a current allocation of 0 A.

As a power storage device 106 comes to the end of a charging period (i.e., when the power storage device 106 is almost fully charged), the actual current drawn by power storage device 106 and/or charging device 104 connected to power storage device 106 may be less than the current demand. Accordingly, at least some of the current allocated using method 400 and/or method 600 may go unused by charging devices 104 and/or power storage devices 106.

To maximize the use of the total available current, instead of using the current demand to allocate current, the actual current used in the previous cycle may be utilized (e.g., in blocks 406, 416, 616, and 616). However, instabilities in power storage device 106 and/or vehicle controller 110 may result in fluctuations in actual usage, resulting in fluctuations in the allocated current that may cause the total available current to be exceeded, incurring fines. Further, upon connecting power storage device 106 to a charging device 104 in charging system 300, the priority of all charging devices 104 may dynamically change.

FIG. 7 is a flow diagram of an exemplary method 700 that may be used to determine use a current demand or an actual current usage (e.g., determined using meter 212 (shown in FIG. 2)) in the current allocation schemes described herein. Method 700 utilizes a stability counter for each charging device 104 which prevents utilizing actual current usage until the charging device 104 has consistently drawn less current than the current demand. In an exemplary embodiment, method 700 is performed using processor 202 (shown in FIG. 2). Alternatively, method 700 may be performed by a central control system (not shown) communicatively coupled to charging device 104. In an exemplary embodiment, method 700 is performed once every cycle.

At block 702, charging device 104 receives status messages from other charging devices 104 in charging network 300. At block 704, from the status messages, charging device 104 determines whether any charging devices 104 have switched from an unconnected status to a connected status. If at least one charging device 104 has switched from an unconnected to a connected status, the charging device clears the stability counter (i.e., sets the stability counter equal to zero) at block 706. If no charging devices 104 switched from an unconnected to a connected status, flow proceeds to block 708.

At block 708, charging device 104 determines whether the current allocated for the previous cycle is greater than the current actually used by charging device 104. If the current allocated is not greater than the current used, the charging device clears the stability counter at block 706. If the current allocated is greater than the current used, flow proceeds to block 710.

At block 710, the stability counter for charging device 104 is incremented by one. At block 712, charging device 104 determines whether the stability counter is greater than a predefined stability limit. If the stability counter is not greater than the stability limit, method ends at block 714.

If the stability is greater than the stability limit, an optimization flag is activated at block 716. With the optimization flag activated, instead of reporting current demand in the status message, charging device 104 reports the actual current usage for the previous cycle, and actual current usage is used instead of current demand for charging device 104 in method 400 and/or method 600.

FIG. 8 is a flow diagram of an exemplary method 800 for allocating current to a plurality of charging devices, such as charging devices 104 (shown in FIGS. 2 and 3). At block 802, each of the plurality of charging devices broadcasts a status message. At block 804, each of the plurality of charging devices 104 receives the broadcasted status messages. The status messages may be broadcasted and received over a communications network, such as peer-to-peer network 316 (shown in FIG. 3).

From the information included in the status messages, at block 806 each charging device calculates a current allocation for every charging device and/or associated power storage device. In an exemplary embodiment, the current allocations are calculated based at least on a connect time of each charging device. For example the current allocations may be calculated using method 400 (shown in FIG. 4) and/or method 500 (shown in FIG. 5). At block 808, each charging device is controlled such that each charging device and/or power storage device receives the allocated amount of current. For example, current control device 214 (shown in FIG. 2) may be controlled to limit the current drawn by a charging device and/or the current supplied to the associated power storage device to the current allocation.

The systems and methods described herein provide current allocation schemes for charging devices used to charge electric vehicles. A first-come first-served allocation scheme is utilized in which vehicles with longer connect times receive charging priority over vehicles with shorter connect times. The first-come first-served allocation scheme may also be implemented within priority tiers. If a communications failure occurs, the first-come first-served current allocation scheme reverts to an equal access current allocation scheme.

As described herein, a robust and effective charging device is provided. The charging device includes a processor configured to selectively activate a current control device to supply current to a power storage device of an electric vehicle. The charging device is coupled to at least one other charging device within a peer-to-peer network, and each charging device within the network is configured to receive current from a common electrical distribution device. The charging device determines a desired amount of current to be received and/or provided to the power storage device and determines an amount of current received by and/or supplied by each charging device within the network. A total amount of current available to be received by the charging device and/or provided to the power storage device by the electrical distribution device is determined by summing the current received and/or supplied by each charging device and subtracting the result from a current distribution limit of the electrical distribution device. The charging device may receive and/or supply the desired amount of current, a reduced amount of current, or no current to the power storage device based on a comparison of the desired amount of current and the total available current. Accordingly, each charging device within the network determines whether the electrical distribution device has enough current distribution capability to supply the desired amount of current to each charging device. As such, the charging devices are prevented from exceeding the current distribution limit of the electrical distribution device.

A technical effect of the devices and methods described herein includes at least one of (a) assigning, based at least on a connect time of a power storage device to a charging device, a current allocation to the charging device; and (b) controlling a current control device to enable the current allocation to be at least one of received from an electrical distribution device and supplied by the charging device.

Exemplary embodiments are described above in detail. The systems and methods disclosed are not limited to the specific embodiments described herein, but rather, components of the charging device and/or system and/or steps of the method may be utilized independently and separately from other components and/or steps described herein. For example, the charging device may also be used in combination with other power systems and methods, and is not limited to practice with only the electric vehicle as described herein. Rather, the exemplary embodiment can be implemented and utilized in connection with many other power system applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A charging device for use with an electric vehicle including a power storage device, said charging device comprising:
a current control device configured to selectively enable current to be received at said charging device from an electrical distribution device and supplied to a power storage device connected to said charging device; and
a processor coupled to said current control device and configured to:
assign, based at least in part on a connect time of the power storage device to said charging device, a current allocation to said charging device; and
control said current control device to enable the current allocation to be at least one of received from the electrical distribution device and supplied by said charging device.

2. A charging device in accordance with claim 1, wherein to assign a current allocation, said processor is configured to:
assign the current allocation after assigning a current allocation to any additional charging devices having a connect time longer than the connect time of the power storage device to said charging device; and
assign the current allocation before assigning a current allocation to any additional charging devices having a connect time shorter than the connect time of the power storage device to said charging device.

3. A charging device in accordance with claim 1, wherein to assign a current allocation, said processor is configured to:
determine an available current; and
assign said charging device a current allocation equal to the lesser of the available current and a current demand associated with said charging device.

4. A charging device in accordance with claim 1, wherein to assign a current allocation, said processor is configured to assign the current allocation based on at least the connect time and a priority tier associated with said charging device.

5. A charging device in accordance with claim 4, wherein to assign a current allocation, said processor is configured to:
assign the current allocation after assigning a current allocation to any additional charging devices having a higher priority tier than the priority tier associated with said charging device;
assign the current allocation after assigning a current allocation to any additional charging devices having the same priority tier as said charging device and a connect time longer than the connect time of the power storage device to said charging device;
assign the current allocation before assigning a current allocation to any additional charging devices having the same priority tier as said charging device and a connect time shorter than the connect time of the power storage device to said charging device; and
assign the current allocation before assigning a current allocation to any additional charging devices having a lower priority tier than the priority tier associated with said charging device.

6. A charging device in accordance with claim 1, wherein said charging device further comprises a network interface configured to broadcast a status message that includes the connect time.

7. A system for use in providing current to a plurality of electric vehicles, said system comprising:
a first charging device configured to receive current from an electrical distribution device and supply at least a portion of the current received to a first power storage device;
a second charging device configured to receive current from the electrical distribution device and supply at least a portion of the received current to a second power storage device; and
a processor configured to:
determine a first connect time of said first charging device to the first power storage device;
determine a second connect time of said second charging device to the second power storage device; and
assign a current allocation to said first and second charging devices based at least in part on the first and second connect times.

8. A system in accordance with claim 7, wherein to assign a current allocation, said processor is configured to:
determine an amount of total available current;
assign said first charging device a current allocation equal to the lesser of the total available current and a first current demand associated with said first charging device, wherein the first connect time is longer than the second connect time;
calculate an amount of remaining available current; and
assign said second charging device a current allocation equal to the lesser of the remaining available current and a second current demand associated with said second charging device.

9. A system in accordance with claim 7, wherein said processor is further configured to:
determine a first priority tier associated with said first charging device; and
determine a second priority tier associated with said second charging device, wherein to assign a current allocation, said processor is configured to assign a current allocation based on the first and second connect times and the first and second priority tiers.

10. A system in accordance with claim 9, wherein said first charging device comprises a user interface configured to receive input from a user selecting the first priority tier.

11. A system in accordance with claim 9, wherein said processing device is configured to:
determine an amount of total available current; and
assign said first charging device a current allocation equal to the lesser of the total available current and a first current demand associated with said first charging device, wherein the first priority tier is higher than the second priority tier.

12. A system in accordance with claim 9, wherein said processing device is configured to:
determine an amount of total available current; and
assign said first charging device a current allocation equal to the lesser of the total available current and a first current demand associated with said first charging device, wherein the first connect time is longer than the second connect time and the first priority tier is the same as the second priority tier.

13. A method for allocating current to a plurality of charging devices communicatively coupled to one another over a peer-to-peer network and each connected to a respective power storage device, said method comprising:
broadcasting, from each of the plurality of charging devices, a status message that includes a connect time of the respective charging device;
receiving, at a processor, the plurality of status messages; and
calculating, using the processor, a current allocation for each of the plurality of charging devices based at least in part on the connect time of each charging device.

14. A method in accordance with claim 13, wherein each of the status messages further includes a priority tier associated with the respective charging device, and wherein calculating a current allocation comprises calculating a current allocation based on the connect time and the priority tier of each charging device.

15. A method in accordance with claim 13, wherein calculating a current allocation comprises:
determining a total available current; and
assigning a first charging device of the plurality of charging devices a current allocation equal to the lesser of the total available current and a first current demand associated with the first charging device, wherein the connect time of the first charging device is the longest connect time of the plurality of charging devices.

16. A method in accordance with claim 15, further comprising
calculating an amount of remaining available current; and
assigning a second charging device a current allocation equal to the lesser of the remaining available current and a second current demand associated with the second charging device, wherein the connect time of the second charging device is the second longest connect time of the plurality of charging devices.

17. A method in accordance with claim 13, further comprising:
detecting a communications failure on the peer-to-peer network;
determining a total available current; and
in response to detecting the communications failure, calculating the current allocation for each of the plurality of charging devices as the total available current divided by the number of charging devices in the plurality of charging devices.

18. A method in accordance with claim 17, wherein detecting a communications failure comprises receiving, at the processor, at least one status message including a peer communication error flag.

19. A method in accordance with claim 17, wherein detecting a communications failure comprises detecting, using the processor, a failure to receive the status message from at least one of the plurality of charging devices.

20. A method in accordance with claim 13, further comprising controlling a current control device of each of the plurality of charging devices to enable each calculated current allocation to be at least one of received at the respective charging device and supplied to the respective power storage device.
